(19) United States
(12) Patent Application Publication
(10) Pub. No.: US 2003/0140686 A1
(43) Pub. Date: Jul. 31, 2003

(54) Method, computer program, and device for measuring the injection quantity of injection nozzles, especially for motor vehicles

(76) Inventors: Ralf Bindel, Winterbach (DE); Ralf Schulte, Markgroeningen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/203,298

(22) PCT Filed: Dec. 1, 2001
(86) PCT No.: PCT/DE01/04515

(30) Foreign Application Priority Data
Dec. 19, 2000 (DE) 10061433.7

(51) Int. Cl. G01M 15/00

(52) U.S. Cl. 73/119 A

(57) ABSTRACT

In a method for measuring the injection quantity of injection nozzles (24), in particular for motor vehicles and in particular in production testing, testing fluid (32) is injected into a measuring chamber (30) by an injection nozzle (24). This imparts movement to a piston (16), which at least partially defines the measuring chamber (30). The movement of the piston (16) is detected by a detection device (42), which generates a corresponding measurement signal (sm). In order to increase the measurement precision, the invention proposes that an effective quantity (Vn) and at least one disturbance quantity (Ve) be obtained through the use of the measuring signal (sm), where the effective quantity (Vn) in turn essentially corresponds to the actual injection quantity (mi).

### PRIOR ART

The current invention relates first to a method for measuring the injection quantity of injection nozzles, in particular for motor vehicles and in particular in production testing, in which a testing fluid is injected into a measuring chamber by an injection nozzle and a resulting movement of a piston, which at least partially defines the measuring chamber, is detected by a detection device, which generates a corresponding measurement signal.

A method of this kind is known on the market and uses a device, which is referred to as an injected fuel quantity indicator.

This component is comprised of a housing in which a piston is guided. The inner chamber of the housing and the piston define a measuring chamber, which is filled with a testing oil. This measuring chamber has an opening against which an injection nozzle can be placed in a pressure-tight manner. When the injection nozzle injects testing oil into the measuring chamber, the testing oil contained in the measuring chamber is displaced. This causes the piston to move, which is detected by a distance sensor. The volume change of the measuring chamber and of the fluid contained therein and therefore the quantity of testing oil injected can be calculated from the distance traveled by the piston.

In the known injected fuel quantity indicator, a device comprised of a measuring plunger and an inductive distance measuring system is used to measure the movement of the piston. The distance measuring plunger is embodied as a probe or is connected to the piston. When the piston moves, this also causes the measuring plunger to move and finally, the movement of the measuring plunger is detected and a corresponding signal is sent to an evaluation unit.

The known method and the injected fuel quantity indicator that is operated with the method already operate with a very high degree of precision. However, the requirements of such injected fuel quantity indicators have recently increased because now it is also necessary to reliably measure very small partial injection quantities in injections that are comprised of a number of partial injections. The individual partial injections must be measured during a complete injection that is comprised of a number of partial injections. The partial injections here can follow one another in very rapid succession.

The object of the current invention, therefore, is to modify a method of the type mentioned at the beginning so that it is possible to measure the injection quantity of injection nozzles with high resolution, precision, and stability. In particular, it should also be possible to measure individual partial injections during a complete injection that is comprised of a number of partial injections.

This object is attained in that an effective quantity and a disturbance quantity are obtained through the use of the measuring signal; the effective quantity essentially corresponds to the actual injection.

### ADVANTAGES OF THE INVENTION

The significance of this step is that in the method according to the invention, the injected volume is no longer calculated directly from the piston cross section and piston stroke, but is determined on the basis of a mathematical statement. The mathematical statement is used to divide the injected volume into two components: a volume that represents the injection (effective quantity) and a volume that that is a result of disturbances (disturbance quantity) and not of the injection.

In this manner, the components of the movement of the piston that essentially correspond to the injected volume of the testing fluid can be “filtered out” from the measurement signal, which is in turn obtained from the movement of the piston. In this manner, the precision of the injection measurement is increased considerably by means of an intelligent method, without the need for additional parts. The more precise measurement of the testing fluid volume change produced by the injection results in a better resolution, a greater precision, and an improved stability of the measurement. It is consequently possible to reliably measure even extremely small partial injections with the method according to the invention.

Advantageous modifications of the invention are disclosed in the dependent claims.

In a first modification, the invention proposes that at least a part of the disturbance quantity be essentially based on the movement components of the piston that are due to the compressibility of the testing fluid. In fact, a fluid is used for the testing fluid, which has the lowest compressibility possible. For example, oil is one such fluid. Actually, however, no fluid is completely without compressibility. But with the required extremely precise resolution and precision for the measurement, even the very slight compressibility of oil, for example, plays a role. This is taken into account in the modified method according to the invention. In this case, the interrelationship in which the piston oscillates on the compressible oil can be easily understood, for example, in the context of a mass-and-spring model.

Alternatively or in addition to this, the invention also proposes that at least a part of the disturbance quantity be essentially based on the movement components of the piston that are due to a pressure wave, which is present in the testing fluid. The abrupt injection of the testing fluid, which occurs under very high pressure, can lead to the propagation of shock wave fronts in the testing fluid in the measuring chamber, which in the course of their propagation, can also be reflected against the walls of the measuring chamber. These shock waves fronts are accompanied by an abrupt change in the pressure or density of the testing fluid, which can give rise to movement components of the piston that do not describe the actually injected testing fluid volume. These physical circumstances can also be described relatively easily in the context of a mass-and-spring model.

Another modification of the method according to the invention that shares this aim is the one in which at least a part of the disturbance quantity is essentially based on the movement components of the piston that are due to a leakage through the annular gap encompassing the piston. In order for the piston to be able to follow the volume change in the measuring chamber during an injection as immediately as possible, the friction between the piston and the housing encompassing it must be minimized. In general, this means that an annular gap is provided between the piston and the housing encompassing it.

Depending on how high the opposing pressure is on the end of the piston opposite from the measuring chamber, a leakage flow of the testing fluid through this annular gap can occur. The greater the difference is between the pressures on both sides of the piston, the greater this leakage flow is. However, such a leakage flow allows testing fluid to flow out of the measuring chamber or into the measuring chamber, which leads to a movement of the piston that does not directly coincide with the injected testing fluid volume. The proposed modification of the invention attempts to compensate for this.

It goes without saying that the precision in the determination of the disturbance quantity and consequently the precision of the measurement of the quantity of injected testing fluid can be increased by detecting other parameters that are essential to the disturbance quantity. For example, these include the temperature in the measuring chamber, which influences the viscosity of the testing fluid. The speed and acceleration of the piston also play a role. The geometric particularities of the device can also be taken into account. However, the invention already achieves a considerable improvement in measurement precision even without such additional state quantities.

One simple possibility for obtaining the effective quantity that essentially corresponds to the actual injection is comprised in determining the effective quantity by subtracting the disturbance quantity from a total quantity.

The precision of the method according to the invention is further increased by executing the division into the effective quantity and the disturbance quantity by means of a mathematical statement, in particular a mathematical algorithm.

An observer method, in particular a Luenberger observer method and/or a filter method, in particular a Kalmann or Kalmann-Bucy filter method are particularly suitable in this regard. The mathematical algorithm, however, can also include a parameter estimation method.

The invention also relates to a computer program, which is suitable for executing the above method, when it is run on a computer. It is particularly preferable if the computer program is stored in a memory, in particular a flash memory.

In addition, the invention relates to a device for measuring the injection quantity of injection nozzles, in particular for motor vehicles, and in particular in production testing, having a measuring chamber into which a testing fluid can be injected by an injection nozzle, having a piston, which at least partially defines a measuring chamber, and having a detection device, which detects a movement of the piston and generates a corresponding measurement signal.

In order to increase the measurement precision, the resolution, and the stability of the measurement, particularly with the injection of very small partial injection quantities, the invention proposes that the device include a processing unit in which an effective quantity and a disturbance quantity are obtained through the use of the measuring signal; the effective quantity in turn essentially corresponds to the actual injection.

A particularly preferable device is one in which the processing unit is provided with a computer program according to one of claims 10 or 11.

### DRAWINGS

An exemplary embodiment of the invention will be explained in detail below in conjunction with the accompanying drawings.

FIG. 1 shows a partially sectional view of a region of a device for measuring the injection quantity of injection nozzles; and

FIG. 2 shows a flowchart of a method for operating the device from FIG. 1.

### DESCRIPTION OF THE EXEMPLARY EMBODIMENT

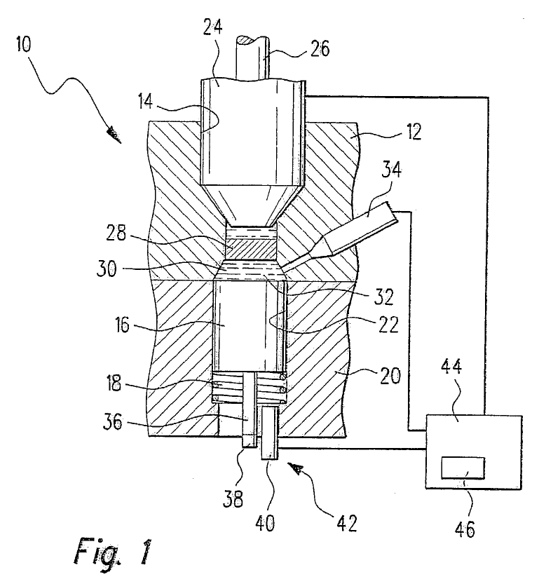

In FIG. 1, a device for measuring the injection quantity of injection nozzles is labeled as a whole with the reference numeral 10. It includes a central block 12, which is secured to a machine frame in a manner that is not shown in detail in the drawing. A stepped bore 14 is let into the central block 12. A cylindrical, closed piston 16 is inserted into the upper section of the stepped bore 14 and is acted on in an upward direction by a spiral spring 18. The spiral spring 18 is supported at the bottom against a shoulder (unnumbered) of the stepped bore 14 in the central block 12.

An adapter part 20 is placed in a pressure-tight fashion against the central block 12. It also contains a stepped bore 22, which in the assembled state shown in FIG. 1, extends coaxial to the stepped bore 14 in the central block 12. An injection nozzle 24 is inserted into the stepped bore 22 from above and is sealed in relation to the stepped bore 22 by means of seals that are not shown. The injection nozzle 24 is in turn connected to a high pressure testing fluid supply 26. An injection damper 28 is inserted into the lower region of the stepped bore 22 in the adapter part 20.

Between the top of the piston 16 (in the upper end position of the piston 16 shown in FIG. 1) and the injection damper 28, the stepped bore 22 in the adapter part 20 is conically embodied and defines a measuring chamber 30. This measuring chamber is filled with a testing fluid, in this case, a testing oil 32 that approximates as closely as possible the properties of the fuel to be injected by the injection nozzle 24. The temperature of the testing oil 32 in the measuring chamber 30 is detected by a temperature sensor 34. In an exemplary embodiment that is not shown, still other sensors are provided for determining the state of the testing oil 32 in the measuring chamber 30, e.g. a microphone for detecting turbulent flow and/or the passage of a pressure wave, etc.

The lower end of the piston 16 shown in FIG. 1 has a plunger 36 fastened to it, which extends essentially coaxial to the stepped bore 14 in the central block 12 and also coaxial to the piston 16. At its end, the plunger 36 supports a magnet section 38 that, together with a coil 40, constitutes an inductive distance sensor 42. On the output side, this distance sensor 42 is connected to a control and regulating unit 44, which also receives signals from the temperature sensor 34. The control and regulating unit 44 can be programmed by means of an operating unit, not shown in the Figure, and also controls the injection nozzle 24. Among other things, the control and regulating unit 44 also includes a timing unit 46.

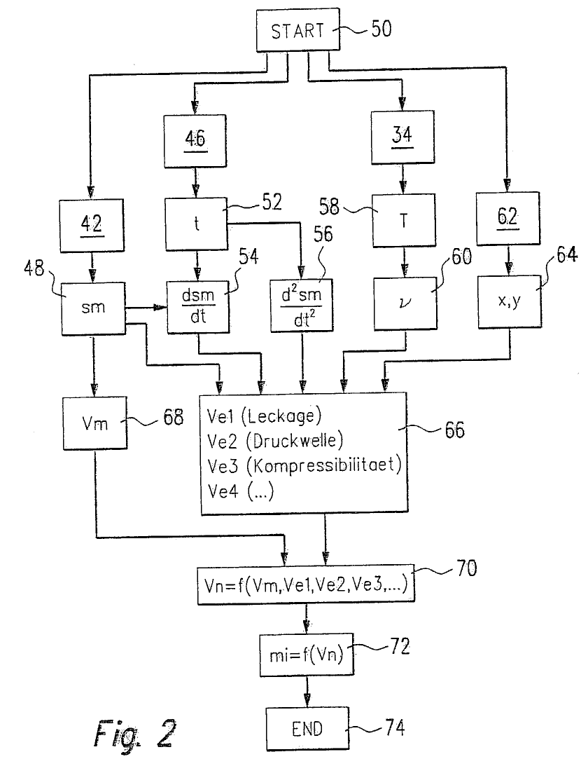

The device 10 shown in FIG. 1, which is for measuring the injection quantity of injection nozzle 24, functions according to a method, which is stored as a computer program in the control and regulating unit 44 and will now be explained in conjunction with FIG. 2:

Induced by the control and regulating unit 44, testing fluid 32 is supplied to the injection nozzle 24 by the high pressure testing fluid supply 26 and is injected via the injection damper 28 into the measuring chamber 30, which is likewise filled with testing fluid 32. The injection damper 28 should prevent the injection jet from striking directly against the top of the piston 16 and exerting a movement component on it that is not caused by the volume change of the testing fluid 32 in the measuring chamber 30 due to the injection.

Due to the injection of testing fluid 32 into the measuring chamber 30, the testing fluid volume in the measuring chamber 30 increases, which presses the piston 16 downward, counter to the force of the spiral spring 18 in the installation position shown in FIG. 1. This also imparts movement to the plunger 36 and its magnet section 38, which results in a signal of the inductive distance sensor 42 that corresponds to the distance traveled by the magnet section 38. In FIG. 2, this measuring signal is labeled sm (block 48). In the method shown in FIG. 2, after the start in block 50, the measuring signal sm is processed as follows:

The timing unit 46 determines the time t (block 52) during which the piston 16 is moved the distance sm. In block 54, the speed dsm/dt is determined based on this time. Also in block 56, the acceleration d²sm/dt² of the piston 16 is calculated. In addition, a viscosity v is calculated from the temperature T of the testing oil 32 in the measuring chamber 30 measured by the temperature sensor 34 (block 58). In addition, a memory 62 supplies geometric data about the device 10, e.g. the cross sectional area of the piston 16, the size of the annular gap between the piston 16 and the stepped bore 14 in the central block 12, the mass of the piston 16, the opposing pressure on the end of the piston 16 opposite from the measuring chamber 30, etc. (block 64).

A number of disturbance quantities Ve are then determined in a logic circuit 66 based on the supplied data regarding distance (block 48), speed (block 54), and acceleration (56) of the piston 16, viscosity of the testing oil 32 (block 60), and other device-specific data (block 64). The determination of these disturbance quantities can be executed on the basis of simple physical models or also on the basis of complex mathematical algorithms used in control engineering, for example a Luenberger observer method, a Kalmann-Bucy filter method, or a parameter estimation method.

The disturbance quantity Ve1 takes into account, for example, the leakage of testing oil 32 through the annular gap formed between the piston 16 and the stepped bore 14 in the central block 12. The amount of the leakage depends to a considerable degree on the temperature T of the testing oil 32, which in turn influences the viscosity v. The logic circuit 66 also calculates a disturbance quantity Ve2, which is based on the movement of the piston 16 that is due to a pressure wave caused by the injection. This is in turn considerably influenced by the acceleration of the piston 16 determined in block 56. The logic circuit 66 also calculates a disturbance quantity Ve3, which takes into account the finite compressibility of the testing oil 32. In this connection, a simple mass-and-spring model can also be used since the testing oil volume disposed in the measuring chamber 30 can also be viewed as a spring and the corresponding piston 16 can be viewed as a mass.

Based on the distance sm determined by inductive distance sensor 42 (block 48) and the cross section of the piston 16, a measurement displacement volume Vm is calculated in block 68. Based on this volume and the disturbance quantities Ve1, Ve2, Ve3, a volume Vn is calculated in block 70, which represents a so-called effective quantity, which essentially describes the volume that actually travels into the measuring chamber 30 by means of the injection nozzle 24. In the current exemplary embodiment, this effective quantity Vn is obtained by subtracting the disturbance quantities Ve1, Ve2, and Ve3 from the measured total volume Vm. Finally, in block 72, the mass mi of testing oil 32 injected during the injection is determined based on the effective quantity Vn. The method shown in FIG. 2 ends at an end block 74.

The method indicated above can considerably improve the resolution, precision, and stability of the measurement, without the need for additional hardware components. Because the disturbance quantities that distort the measurement quantity are eliminated from the measurement quantity, a final value is obtained, which can describe the injected testing oil quantity very precisely. The method can also be used to detect extremely small partial injection quantities with a high degree of precision.

One possibility for further increasing the above-mentioned precision could be comprised, for example, not of determining an integral speed or acceleration of the piston 16 in blocks 54 and 56, but in detecting a speed and acceleration progression during the movement of the piston 16. The disturbance quantities thus determined would be even more precise, which would also have a direct effect on the precision of the final result. Moreover, through the use of mathematical algorithms, for example the Luenberger observer method, the disturbance quantities can be determined with greater precision, without having to measure all of the state quantities.

1. A method for measuring the injection quantity of injection nozzles (24), in particular for motor vehicles and in particular in production testing, in which a testing fluid (32) is injected into a measuring chamber (30) by an injection nozzle (24) and a movement of a piston (16), which at least partially defines the measuring chamber (30), is detected by a detection device (42), which generates a corresponding measurement signal (sm), characterized in that an effective quantity (Vn) and at least one disturbance quantity (Ve) can be obtained through the use of the measuring signal (sm), where the effective quantity (Vn) essentially corresponds to the actual injection.

2. The method according to claim 1, characterized in that at least a part (Ve3) of the disturbance quantity (Ve) is essentially based on the movement components of the piston (16) that are due to the compressibility of the testing fluid (32).

3. The method according to one of claims 1 or 2, characterized in that at least a part (Ve2) of the disturbance quantity (Ve) is essentially based on the movement components of the piston (16) that are due to a pressure wave, which is present in the testing fluid (32).

4. The method according to one of the preceding claims, characterized in that at least a part (Ve1) of the disturbance quantity (Ve) is essentially based on the movement components of the piston (16) that are due to a leakage through the annular gap encompassing the piston (16).

5. The method according to one of the preceding claims, characterized in that the effective quantity (Vn) is determined by subtracting the disturbance quantity (Ve) from a total quantity (Vm).

6. The method according to one of the preceding claims, characterized in that the division into the effective quantity (Vn) and the disturbance quantity (Ve) is executed by means of a mathematical algorithm (66).

7. The method according to claim 6, characterized in that the mathematical algorithm is an observer method, in particular a Luenberger observer method.

8. The method according to one of claims 6 or 7, characterized in that the mathematical algorithm is a filter method, in particular a Kalmann or Kalmann-Bucy filter method.

9. The method according to one of claims 6 to 8, characterized in that the mathematical algorithm is a parameter estimation method.

10. A computer program, characterized in that it is suitable for executing the method according to one of claims 1 to 9, when it is run on a computer.

11. The computer program according to claim 10, characterized in that it is stored in a memory, in particular a flash memory.

12. A device for measuring an injection quantity of injection nozzles (24), in particular for motor vehicles and in particular for production testing, having a measuring chamber (30) into which a testing fluid (32) can be injected by an injection nozzle (24), having a piston (16), which at least partially defines a measuring chamber (30), and having a detection device (42), which detects a movement of the piston (16) and generates a corresponding measurement signal (sm), characterized in that it includes a processing unit (44) in which an effective quantity (Vn) and at least one disturbance quantity (Ve) are obtained through the use of the measuring signal (sm), where the effective quantity (Vn) essentially corresponds to the actual injection.

13. The device according to claim 12, characterized in that the processing unit (44) is provided with a computer program according to one of claims 10 or 11.
